(19) United States
(12) Patent Application Publication
(10) Pub. No.: US 2012/0080247 A1
(43) Pub. Date: Apr. 5, 2012

(54) Vehicle drive

(76) Inventors: Egon Schmid, Sauldorf/Krumbach (DE); Alfred Richter, Kirchheim Teck (DE)

(21) Appl. No.: 12/898,326

(22) Filed: Oct. 5, 2010

(51) Int. Cl. B60K 1/00

(52) U.S. Cl. 180/65.1

(57) ABSTRACT

An invalid vehicle having a drive comprising an electric machine (3) which comprises an output shaft (4), and with an axle (2) which is operatively connected to the output shaft (4) via a drive transmission region (7) of the axle (2), wherein the output shaft (4) of the electric machine (3) is arranged substantially parallel to the axle (2), and the drive transmission region (7) is arranged substantially in the center of the axle (2).

### BACKGROUND OF THE INVENTION

The invention relates to a drive for an invalid vehicle.

Drives for electric invalid chairs have an electric machine which drives the rear axle. The electric machine has a comparatively large mass in comparison to the overall mass of the invalid chair and is therefore customarily arranged in the center of the invalid chair, in particular in the center with respect to the driven axle, in order to reduce the risk of the invalid chair tipping over. A transmission is arranged on that side of the electric machine on which the output shaft emerges out of the housing of the electric machine. The output shaft is operatively connected to the driven axle via the transmission. On both sides thereof, the driven axle has wheels which are thus driven by the electric machine.

A problem in the known prior art is the frequently insufficient mounting of the wheels, wherein it should be taken into consideration that, for example as prescribed by legal regulations, invalid chairs or other small passenger-conveying vehicles have a small width. This complicates suspension of the driven wheels individually, which provides the riding comfort, due to a lack of space.

It is the object of the invention to provide a drive for a vehicle, in particular for an invalid chair, in which the abovedescribed problems of the prior art are reduced or eliminated, and in particular it is the object of the invention to provide a corresponding drive, in which improved suspension of the wheels is made possible.

### SUMMARY OF THE INVENTION

To achieve the object, the solution according to the invention arranges a drive transmission region of the driven axle substantially in the center of the axle. Space is thereby provided on both sides of the centrally arranged drive transmission region for better mounting of the wheels. In this case, the drive transmission region of the axle denotes a region of the axle in which the drive torque is transmitted to the axle. This can be undertaken via a gearwheel, via a belt drive or the like. A subassembly comprising the electric machine and a transmission is preferably also arranged centrally with respect to the axle, i.e. the center of gravity of the subassembly is arranged preferably on a plane which is perpendicular to the axle and is in the center with respect to the axle. In this case, with regard to the arrangement of the drive transmission region or with respect to the arrangement of the subassembly, the expression “in the center of the axle” preferably denotes a region which comprises the central 40% of the overall length of the axle or of the width of the vehicle, even more preferably at maximum 30% or 20%, or most preferably 10% or even 5%. The centrally arranged engine affords the advantage of a favorable position for the center of gravity of the entire vehicle.

The invention is suitable in particular for small passenger-conveying motor vehicles, wheelchairs or invalid chairs. The invention is particularly preferably used in an invalid chair, wherein a preferred invalid chair is a single-seater vehicle or has a training mass of max. 300 kg or a design-induced maximum speed of 15 km/h or a max. width of 1.10 m. The permissible overall mass of preferred invalid chairs is 500 kg. The vehicle or the invalid chair is driven preferably exclusively by the electric machine, wherein, if appropriate, a manual drive can also be possible, for example should the electric machine fail. In this case, “exclusively” refers preferably to machine drives. The invention therefore affords particular advantages for small motor vehicles, wheelchairs or invalid chairs, since said vehicles customarily have a small overall size, and therefore complicated mechanical constructions for a comfortable mounting of the driven wheels are less favorable.

The drive preferably comprises a transmission having a fixed step-down ratio, via which the output shaft is operatively connected to the drive transmission region of the axle. The transmission having a fixed step-down ratio affords the advantage of a simple construction, wherein it should be taken into consideration that, when the drive is used in the preferred invalid chairs, a transmission having a fixed step-down ratio in combination with the electric machine is sufficient in order to cover the entire speed range up to a design-induced maximum speed of the invalid chair.

The drive advantageously comprises an intermediate shaft which is arranged, as viewed spatially, between a housing of the electric machine and the axle. The output shaft is operatively connected to the drive transmission region preferably via the intermediate shaft. In this case, “between” means that at least a partial region of the intermediate shaft is arranged between the housing and the axle such that the intermediate shaft transmits torque in the opposite direction to the output shaft of the electric machine, but offset in parallel thereto. In this case, the intermediate shaft is expediently arranged parallel to the output shaft and to the axle. “Substantially parallel” here means parallel within the scope of customary tolerances, and therefore “substantially parallel” can preferably also be replaced by “parallel”, as understood by a person skilled in the art.

In a preferred embodiment, the axle has a differential. A differential affords the advantage of greater riding comfort. The differential is preferably arranged substantially in the center of the axle. This provides sufficient space on both sides for a wheel suspension system affording comfortable riding conditions. In the preferred embodiment, the drive transmission region is assigned to the differential. Preferred embodiments of this type may have a differential with an external gear rim via which the differential is driven, wherein the differential, in turn, drives the wheels of the axle, if appropriate via further shafts. The differential is therefore preferably part of the axle.

The axle advantageously has individually suspended wheels on both sides. This affords the advantage of increased riding comfort. The wheels are advantageously each suspended in a spring-mounted or damped manner. Increased riding comfort is thereby achieved in the driven vehicle. The wheels are expediently each driven via articulated shafts. This permits an individual wheel suspension system and the driving of the wheels. The articulated shafts preferably connect the wheels to the differential. Driving of the wheels is thereby ensured.

### BRIEF DESCRIPTION OF THE DRAWINGS

Preferred embodiments of the invention are described in more detail with reference to the attached figures, wherein

FIG. 1 shows a schematic sectional view of a drive according to the invention, and

FIG. 2 shows a further schematic sectional view of the drive in FIG. 1.

### DETAILED DESCRIPTION

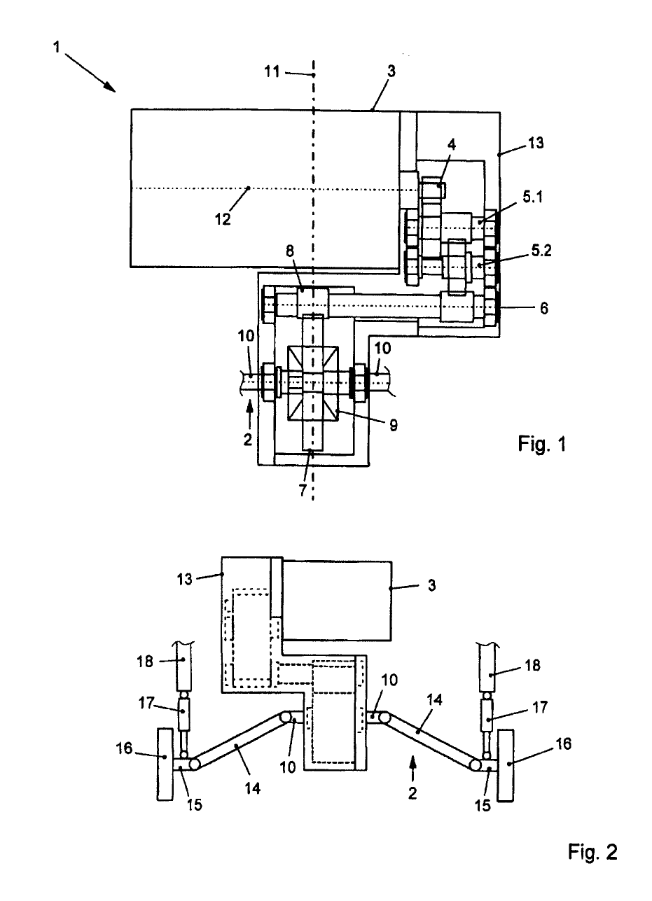

FIG. 1 shows a drive 1 according to the invention schematically in a sectional view. It should be noted that a part of the axle 2 of the drive 1 according to the invention is not shown in FIG. 1. The drive 1 according to the invention comprises an electric machine 3 which acts via an output shaft 4 on a first transmission shaft 5.1 which, in turn, acts on a second transmission shaft 5.2. The second transmission shaft 5.2 is in engagement with an intermediate shaft 6. The intermediate shaft 6 transmits the torque in a direction of the housing of the electric machine 3 in a direction parallel to the output shaft 4 of the electric machine 3. At the output end of the intermediate shaft 6, the torque is transmitted to a drive transmission region 7 of the axle 2. The output transmission region 7 is formed by an outer gear rim which is in engagement with a pinion 8 mounted on the intermediate shaft 6. Furthermore, FIG. 1 schematically shows a differential 9 which is driven by the drive transmission region and drives differential output shafts 10 on both sides in each case. The differential output shafts 10 are part of the axle 2.

FIG. 1 also schematically indicates a center plane 11 of an invalid chair which is driven by the drive 1. The drive transmission region 7 is arranged in the center plane 11, i.e. centrally with respect to the axle 2 and therefore centrally with respect to the entire invalid chair. In addition, a center of gravity 12 of the subassembly comprising the electric machine 3 and the transmission 13 is arranged in the vicinity of the center plane 11. This ensures uniform weight distribution of the mass of the drive 1 in the invalid chair. The central arrangement of the drive transmission region 7 ensures that there is still sufficient space on both sides of the differential 9 in order to arrange a mechanically complicated individual wheel suspension system or the like.

FIG. 2 once again shows the drive 1 according to the invention from FIG. 1 in a further sectional view, but in the opposite viewing direction. In FIG. 2, the same reference numbers as in FIG. 1 are used for the same parts, wherein, in the illustration of FIG. 2, some of the parts or reference numbers shown in FIG. 1 have been omitted for the sake of clarity. FIG. 2 serves in particular to show further elements of the axle 2.

The axle 2 which is driven by the electric machine via the transmission 13 comprises articulated shafts 14 which connect the differential output shafts 10 to wheel shafts 15. Wheels 16 are in each case mounted on the wheel shafts 15. The driving of the wheels 16 via the articulated shafts 14 permits the wheels 16 to be individually suspended, wherein, of the individual wheel suspension system of the wheels 16, FIG. 2 shows, merely schematically, spring-damper elements 17 via which the carrying force of the wheels 16 is transmitted to a frame 18 of the invalid chair driven by the drive 1. By means of the wheels 16 being individually suspended by the spring-damper element 17, high riding comfort of the invalid chair is ensured.

1-12. (canceled)

13. An invalid vehicle, comprising a drive, comprising an electric machine (3) having an output shaft (4), and an axle (2) which is operatively connected to the output shaft (4) via a drive transmission region (7) of the axle (2), wherein the output shaft (4) of the electric machine (3) is arranged substantially parallel to the axle (2), and the drive transmission region (7) is arranged substantially in the center of the axle (2).

14. An invalid vehicle according to claim 13, wherein the output shaft (4) is operatively connected to the drive transmission region (7) via a transmission having a fixed step-down ratio.

15. An invalid vehicle according to claim 13, wherein the output shaft (4) is operatively connected to the drive transmission region (7) via an intermediate shaft (6) at least partially arranged between a housing of the electric machine (3) and the axle (2).

16. An invalid vehicle according to claim 13, wherein the axle (2) has a differential (9).

17. An invalid vehicle according to claim 16, wherein the differential (9) is arranged substantially in the center of the axle (2).

18. An invalid vehicle according to claim 16, wherein the drive transmission region (7) is assigned to the differential (9).

19. An invalid vehicle according to claim 13, wherein the axle (2) has individually suspended wheels (16) on both sides.

20. An invalid vehicle according to claim 19, wherein the wheels (16) are each suspended in a spring-mounted and/or damped manner.

21. An invalid vehicle according to claim 19, wherein the wheels (16) are each driven via articulated shafts (14).

22. An invalid vehicle according to claim 19, wherein the wheels (16) are each connected to the differential (9) via articulated shafts (14).
